(19) United States
(12) Patent Application Publication
(10) Pub. No.: US 2005/0105789 A1
(43) Pub. Date: May 19, 2005

(54) Method and apparatus for detecting, monitoring, and quantifying changes in a visual image over time

(76) Inventors: Hugh S. Isaacs, Shoreham, NY (US); Alan M. Shipley, Sandwich, MA (US); Eric Karplus, East Falmouth, MA (US)

Correspondence Address: BROOKHAVEN SCIENCE ASSOCIATES/;BROOKHAVEN NATIONAL LABORATORY, BLDG. 475D - P.O. BOX 5000, UPTON, NY, 11973, US

(21) Appl. No.: 10/713,809

(22) Filed: Nov. 17, 2003

(51) Int. Cl. G06K 9/00; G06K 9/64

(52) U.S. Cl. 382/141; 382/217

(57) ABSTRACT

A method of quantifying measurements associated with a subject using a visual image of the subject includes acquiring digital representations of first and second images of the subject, determining difference information between the first and second images, and converting this information into physical, chemical, electrical, or electrochemical information concerning the subject. An apparatus for quantifying measurements associated with a subject using a visual image of the subject includes a digital camera and a computer. The camera acquires digital representations of first and second images of the subject. The computer is responsive to the digital representations and determines difference information between the first and second images. The difference information represents a change in a visual parameter between the first and second images. The computer converts the difference information into physical, chemical, electrical, or electrochemical information associated with the subject.

This invention was made with Government support under contract number DE-AC02-98CH10886, awarded by the U.S. Department of Energy. The Government has certain rights in the invention.

### BACKGROUND OF THE INVENTION

1. Field of the Invention

The present invention generally relates to a method and apparatus for locating changes that take place over time in a visual image, and relates more particularly to a computerized method for digitally processing temporal images to enhance potentially minute changes in the image.

2. Description of the Prior Art

It is extremely difficult to detect and monitor small changes that occur in a visual image over considerable periods of time due to obvious limitations in human observation, perception, and concentration. The average viewer begins to discern change in images only after a substantial amount of change has occurred in a relatively concentrated region.

However, many physical phenomenona, such as the corrosion of a metallic surface, typically occur over a relatively broad area and may even regress in some areas such that the observer is completely unable to detect any alteration in the surface whatsoever. Thus, there is a need for enhancing changes that occur in a visual image over time to enable detection by an average human observer.

In addition, as with any human observation, a subjective measure of the amount of change at any given time is difficult to compare with another such quantity, particularly when viewed by different observers. Therefore, there is a need to attach a quantitative value that represents changes occurring in a visual image, which may readily be stored, processed, and compared with other such quantities.

Further, conventional techniques for detecting change that utilize, for instance, scanning probe microscopes, are severely limited with respect to dynamically locating the position and degree of changes in an image on a real-time basis. Such approaches are typically too cumbersome, especially when presented with a significant amount or rate of change over a broad area. Thus, there is a need for a method and apparatus to quantitatively detect and monitor changes in visual images in real time.

Conventional methods exist to digitize images of, for instance, portions of the human body. X-ray video imaging manipulates transmitted light and shadows, which makes it particularly suitable for studying anatomical objects. However, such techniques cannot be used to monitor spectral changes in an image. Furthermore, such techniques are not suitable for making quantitative, localized measurements of electrochemical activity, which is extremely valuable information for the study of processes such as corrosion.

One example of an electrochemical quantity of interest in the study of processes, such as corrosion, is pH. Conventional methods have established that it is possible to use spectral information obtained from pH sensitive color indicator dyes to obtain an accurate measurement of pH, as described in Robert-Baldo, Gillian L.; Morris, Michael J.; Byrne, Robert H., Spectrophotometric Determination of Seawater pH Using Phenol Red, Analytical Chemistry, vol. 57 (November 1985) pp. 2564-2577 and Yao, Wensheng; Byrne, Robert H., Spectrophotometric Determination of Freshwater pH Using Bromocresol Purple and Phenol Red, Environmental Science and Technology, vol. 35 no. 6 (Mar. 15, 2001) pp. 1197-1201. This art has focused on using a spectrophotometer to monitor molecular absorbance of pH sensitive dyes.

Manufacturers such as OceanOptics located at 380 Main Street, Dunedin, Fla. 34698, offer probe-style products that can be used in much the same way as standard electrochemical pH probes. A major limitation of both of these techniques, however, is that the probes are generally quite large, and even if they could be made very small, the fact that the probes only measure a single value averaged over the active area requires that a scanning approach be used to obtain a map of pH over an extended surface. This would be a very slow process, with the time required increasing in proportion to the square of the spatial resolution required, that is, doubling the resolution for an M×N point area requires 2M×2N points.

### OBJECTS AND SUMMARY OF THE INVENTION

It is an object of the present invention to provide a method and apparatus that are able to detect, enhance, and quantify physical, chemical, and electrochemical changes manifested in a visual image, such as pH, lead content, zinc content, potential difference, pitting, and corrosion, that occur over a period of time so that a human observer can readily discern these changes.

It is another object of the present invention to provide a portable method and apparatus that are able to provide rapid, precise quantitative indications of changes that occur in a relatively large area over time.

It is yet another object of the present invention to provide an efficient and cost-effective computer-based method and apparatus for detecting and monitoring changes that occur in a visual image in near real time with high resolution.

It is still another object of the present invention to provide a method and apparatus for detecting, monitoring, and quantifying robust spectral information representing changes that occur in a visual image over time.

A method of quantifying measurements associated with a subject using a visual image of the subject in accordance with one form of the present invention, which incorporates some of the preferred features, includes the steps of acquiring digital representations of first and second images of the subject, determining difference information in the digital representations of the first and second images, and converting the difference information into chemical, physical, electrical, or electrochemical information associated with the subject.

The chemical or physical information includes at least one of pH, lead content, zinc content, potential difference, or another parameter of chemical, physical, electrical, or electrochemical significance. The visual parameter includes at least one of color, tint, hue, brightness, and tone.

The method may also include the steps of comparing at least a portion of the difference information to a threshold value, associating that portion of the difference information that is less than or greater than the threshold value with a region of interest, and substituting a predetermined value for that portion of the difference information that is not within the region of interest.

Each of the first and second images includes at least one pixel. The pixels associated with the first image include a first RGB value, and the pixels associated with the second image include a second RGB value. The step of converting difference information may also include the steps of converting the first RGB value into a first rgb tristimulus value; converting the second RGB value into a second rgb tristimulus value; converting the first rgb tristimulus value into a first spectral power distribution; converting the second rgb tristimulus value into a second spectral power distribution; and obtaining an equation representing the chemical, physical, electrical, or electrochemical information as a function of at least one spectral power distribution peak.

The method also includes subtracting one or more elements of the first spectral power distribution and the second spectral power distribution to yield a difference spectral power distribution; and multiplying the difference spectral power distribution by a derivative of the equation representing the chemical, physical, electrical, or electrochemical information as a function of the spectral power distribution peak to represent a change associated with the subject.

An apparatus for quantifying measurements associated with a subject using a visual image of the subject formed in accordance with one form of the present invention, which incorporates some of the preferred features, includes a digital camera and a computer. The digital camera acquires a digital representation of first and second images of the subject. A visual indicator is added to the subject and changes at least one visual parameter in response to a chemical, physical, electrical, or electrochemical change associated with the subject.

The computer is responsive to the digital representations and determines difference information between the first and second images. The computer converts the difference information into information representing the change associated with the subject.

These and other objects, features, and advantages of the invention will become apparent from the following detailed description of illustrative embodiments thereof, which is to be read in connection with the accompanying drawings.

### BRIEF DESCRIPTION OF THE DRAWINGS

FIG. 1 is a pictorial representation of an apparatus formed in accordance with the present invention.

FIG. 2 is a block diagram of a potentiostat for use in the apparatus formed in accordance with the present invention.

FIGS. 3a and 3b are flowcharts of a method in accordance with the present invention.

FIGS. 4a-4f are representative computer screens generated by a software program in accordance with the present invention.

FIG. 5 is a flowchart of a preferred algorithm for implementing a threshold function in accordance with the present invention.

FIGS. 6a-6c are video images of a sample taken at 0, 9, and 19 minutes, respectively.

FIGS. 7a-7c are pH line profiles corresponding to FIGS. 6a-6c, respectively.

FIG. 8a is a plot of a color matching function.

FIG. 8b is a plot of a Spectral Power Distribution (SPD) for the RGB value (106,137,73).

FIG. 9 is a curve fit for pH as a function of SPD peak product at 450 and 600 nm.

FIGS. 10a and 10b are plots of pH as a function of measured color value in RGB space and XYZ space, respectively.

FIG. 11a is a pH line profile as a function of time measure with a tungsten microelectrode.

FIG. 11b is a pH line profile as a function of time measure by the spectral method in accordance with the present invention, in which pH is determined from RGB color values of a source image.

FIG. 12 is a plot of pH values at selected points as a function of time measured with the tungsten microelectrode and the spectral method in accordance with the present invention.

FIGS. 13a-13b are time sequence video images of a sample taken at 0, 9, and 19 minutes, respectively, showing pH maps calculated from RGB values in the source image.

FIGS. 14a-14c are time sequence video images of a sample taken at 0, 9, and 19 minutes, respectively, showing enhanced difference images referenced to the image in FIG. 13a.

FIGS. 15a and 15b are time sequence video images of a sample taken at 0 and 19 minutes, respectively, showing changes in pH along an 8 mm line with respect to a reference condition, measured using three different methods.

### DETAILED DESCRIPTION OF THE PREFERRED EMBODIMENTS

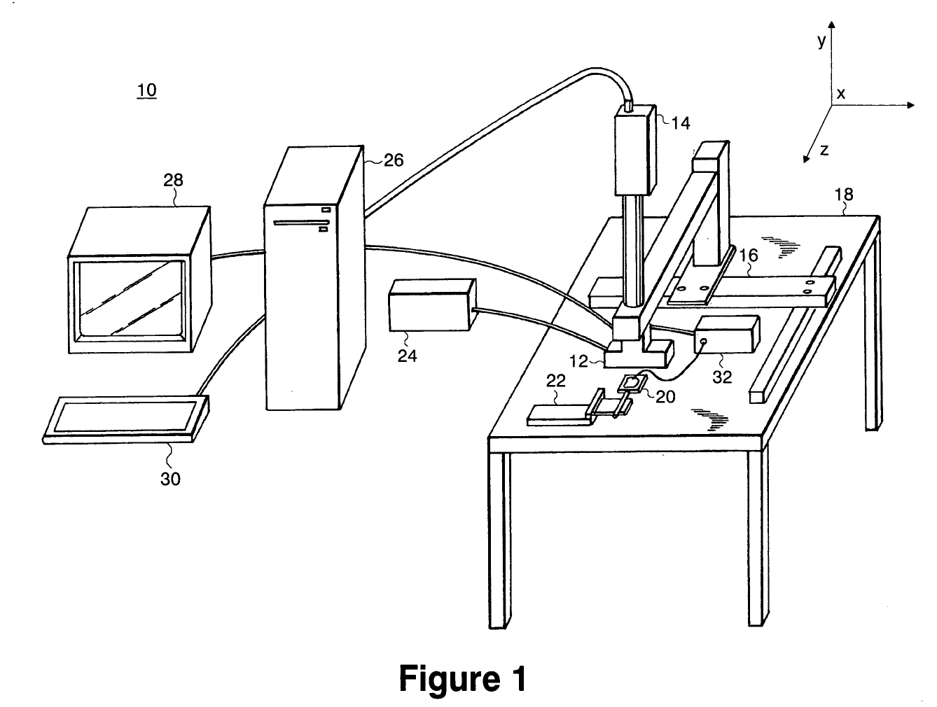

An apparatus 10 for detecting, monitoring, and quantifying changes in a visual image over time is shown in FIG. 1. The apparatus 10 preferably includes a light source 12, which is mounted with a camera 14, such as a digital camera, on a camera positioning bracket 16. The camera positioning bracket 16 is preferably mounted on a horizontal surface, such as a table 18, and permits the camera 14 and light source 12 to be positioned in at least one of an x, y, and z direction above a subject 20 to be monitored.

The light source 12 is preferably selected to optimize the quality of spectral information needed for the desired measurements, and thus may be polychromatic or monochromatic. For example, if a single spectral peak is to be monitored, then a monochromatic source that emits at that spectral peak is preferably used. If multiple peaks must be monitored, then a polychromatic source that emits well at each of the multiple peaks is preferably used.

The subject 20 is preferably mounted on a subject positioning bracket 22, which enables the subject 20 to be selectively positioned in at least one of the x, y, and z directions. The subject positioning bracket 22 is preferably mounted to the same horizontal surface 18 as the camera positioning bracket 16.

The light source 12 preferably provides an adjustable quantity and direction of light and is powered by a supply 24. The camera 14 preferably outputs a digital representation of an image of the subject 20 to a computer 26, such as a personal computer. The computer 26 is preferably coupled to a display 28 and a keyboard 30 so that the user is able to interface with the method and apparatus formed in accordance with the present invention.

The camera 14 preferably provides a digital representation of an intensity corresponding to each of a red, green, and blue color plane for each pixel of an image of the subject 20. Stated differently, for each pixel of the image, three digital values are provided. Each of these digital values preferably represents the intensity of the red, green, or blue color plane corresponding to the associated pixel. Therefore, the camera provides robust spectral information concerning each portion of the image so that changes occurring in that image may be accurately detected, monitored, and quantified over time.

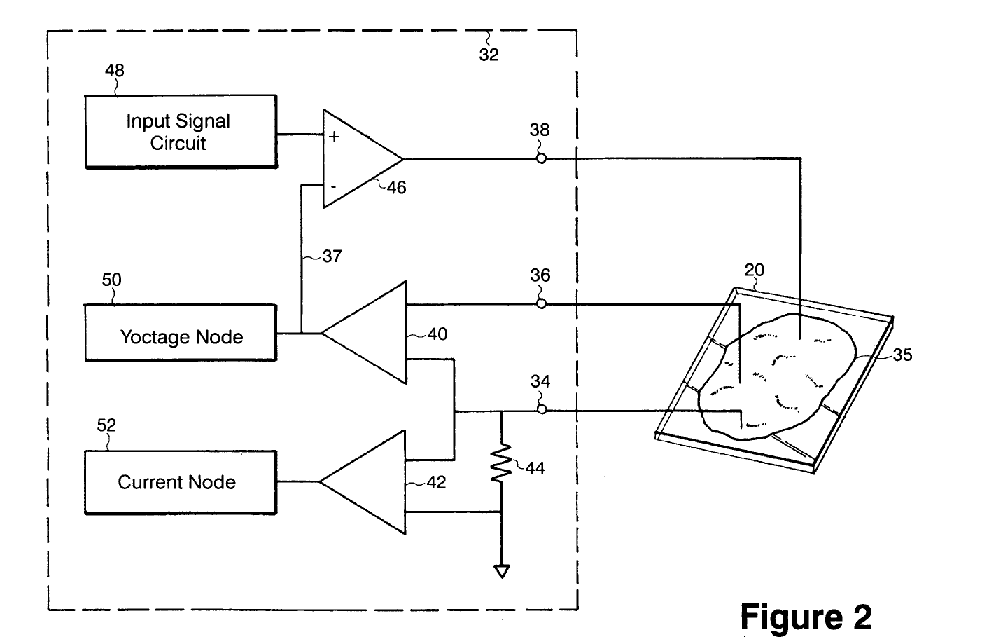

FIG. 1 shows a potentiostat 32, which is shown in greater detail in FIG. 2, that is responsive to electrochemical changes occurring on the subject 20. As shown in FIG. 2, the potentiostat 32 is an electronic device that controls a voltage difference between a working electrode 34 and a reference electrode 36. Both electrodes are preferably incorporated in an electrochemical cell on or in the subject 20.

The potentiostat 32 preferably implements voltage control by injecting current from an auxiliary electrode 38. Typically, the potentiostat 32 measures a current flow between the working electrode 34 and the auxiliary electrode 38. The variable that is being controlled by the potentiostat 32 is preferably a cell potential and the variable that is being measured is preferably a cell current.

For instance, in corrosion testing, the working electrode 34 is typically coupled to corroding metal. The working electrode 34 is preferably not the metallic structure being studied, but rather a small sample used to represent that structure. Generally, the electrochemical reaction being studied occurs at the working electrode 34.

The reference electrode 36 is preferably used to measure the voltage at the working electrode 34. A constant electrochemical voltage is preferably measured at the reference electrode 36 where there is no current flow through the reference electrode 36.

The auxiliary electrode 38 is preferably an inert conductor, such as platinum or graphite, which is located near the working electrode 34. Current preferably flows into the cell 35 from the working electrode 34 and leaves the cell 35 from the auxiliary electrode 38. Each of the electrodes is preferably immersed in an electrolyte or electrically conductive solution.

As shown in the block diagram of FIG. 2, the potentiostat 32 preferably includes an electrometer circuit 40 and a current-to-voltage converter circuit 42. These circuits preferably provide unity gain differential amplification with the output voltage for each of these devices being the difference between the two inputs.

The output of the electrometer circuit 40 and the output of the current-to-voltage converter circuit 42 are preferably a voltage signal at a voltage node 50 and a current signal at a current node 52, respectively. The voltage node 50 and the current node 52 are preferably coupled to analog-to-digital converters in the computer 26 shown in FIG. 1 for digitization and further processing.

The electrometer circuit 40 preferably measures the voltage difference between the reference electrode 36 and the working electrode 34. The output of the electrometer circuit 40 is preferably used as both a feedback signal 37 in the potentiostat 32 and the voltage signal measured at the voltage node 50. An ideal electrometer circuit 40 preferably has zero input current and infinite input impedance. Thus, current flowing through the reference electrode 36 is able to change the potential in the electrometer circuit 40. However, since the electrometer circuit 40 preferably has an input current near zero, this effect may be ignored.

The current-to-voltage converter circuit 42 preferably measures the electrochemical cell current by forcing the cell current to flow through a current measurement resistor 44. The current drop across resistor 44 is preferably a measure of the electrochemical cell current. Since cell current in, for instance, a corrosion experiment often varies by as much as seven orders of magnitude, the electrochemical cell current cannot be measured using a single resistor. Therefore, a bank of different resistors are preferably switched into the current-to-voltage converter 42 under computer control. This enables a widely varying current to be measured using the appropriate value of resistor.

A control amplifier 46 preferably compares the measured electrochemical cell voltage at the voltage node 50 with the desired voltage from an input signal circuit 48 and drives current into the electrochemical cell 35 to force these voltages to be the same. Since the measured voltage is preferably coupled to a negative input of the control amplifier 46, a positive movement in the measured voltage generates a negative output at the control amplifier, which counteracts the positive movement in the measured voltage.

Under normal conditions, the electrochemical cell voltage is preferably controlled to be identical to the voltage provided by the input signal circuit 48. The input signal circuit 48 is preferably a computer controlled voltage source, which is generally implemented as the output of a digital-to-analog converter that converts computer generated numbers into voltages representing, for instance, constant, ramp, and sinusoidal voltage signals.

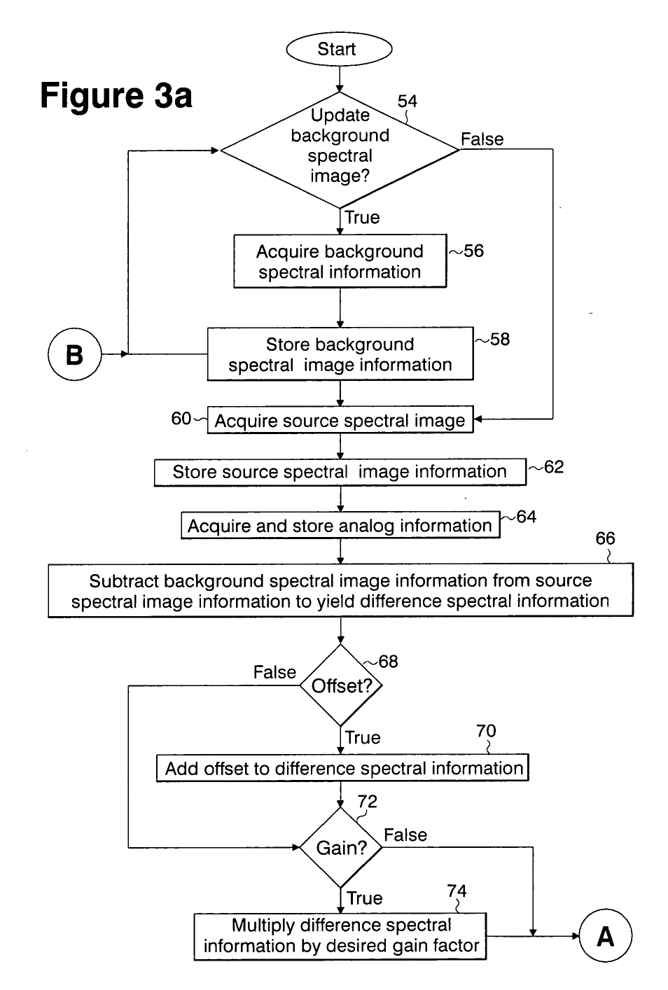

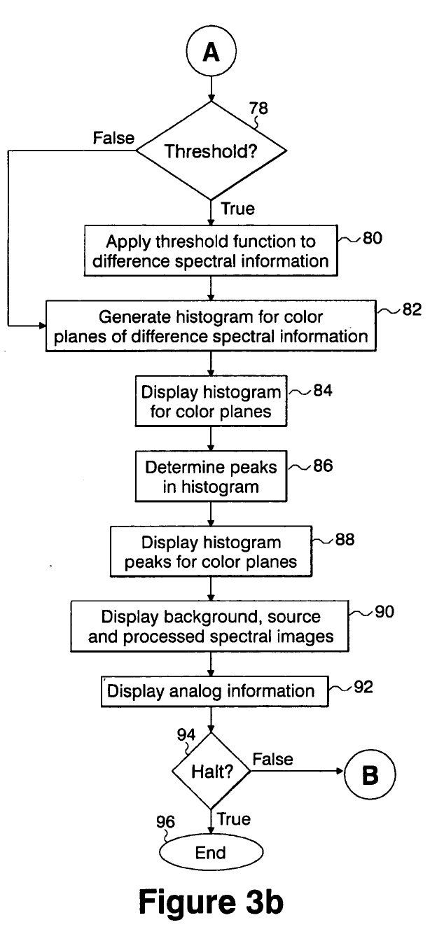

FIGS. 3a and 3b are flowcharts of a method for detecting, monitoring, and quantifying changes in a visual image, such as corrosion of a metallic surface in an aqueous solution, in accordance with the present invention. In step 54, it is determined whether a background spectral image is to be updated and, if so, a new background spectral image is acquired in step 56 and stored in step 58. The background spectral image is used herein as a reference or baseline image, with which subsequent or source images are compared.

If a new background spectral image is not required in step 54, the source spectral image is acquired in step 60 and stored in step 62. The source spectral image is used herein to refer to any image obtained subsequent in time to the background spectral image. Analog information is then preferably acquired from the potentiostat and stored in step 64.

It should be noted that background spectral image information, source spectral image information, and analog information are preferably stored in digital format, such as 8, 16, or 32-bit, signed integer, unsigned integer, or floating point formats. The background spectral image information and the source spectral image information are preferably obtained and stored in an unsigned integer format and preferably converted to floating point format prior to mathematically manipulating these quantities.

In step 66, the background spectral image information is preferably subtracted from the source spectral image information to obtain difference spectral information. For example, assume that the notation “Pb_{1g}” refers to a digital representation of the intensity of the green (g) color plane corresponding to the first (1) pixel (P) in the background (b) image; “Ps_{2b}” refers to the digital representation of the intensity of the blue (b) color plane corresponding to the second (2) pixel (P) in the source (s) image; and “Pd₃ᵣ” refers to the digital representation of the intensity of the red (r) color plane corresponding to the third (3) pixel (P) in the difference (d) image.

Specifically, Equations (1)-(15) represent a preferred sequence for subtracting the background and source spectral image information to generate the difference spectral information for pixels 1-5 in step 66, as follows:
Pd_{1b}=Ps_{1b}−Pb_{1b} (1);
Pd_{1g}=Ps_{1g}−Pb_{1g} (2);
Pd₁ᵣ=Ps₁ᵣ−Pb₁ᵣ (3);
Pd_{2b}=Ps_{2b}−Pb_{2b} (4);
Pd_{2g}=Ps_{2g}−Pb_{2g} (5);
Pd₂ᵣ=Ps₂ᵣ−Pb₂ᵣ (6);
Pd_{3b}=Ps_{3b}−Pb_{3b} (7);
Pd_{3g}=Ps_{3g}−Pb_{3g} (8);
Pd₃ᵣ=Ps₃ᵣ−Pb₃ᵣ (9);
Pd_{4b}=Ps_{4b}−Pb_{4b} (10);
Pd_{4g}=Ps_{4g}−Pb_{4g} (11);
Pd₄ᵣ=Ps₄ᵣ−Pb₄ᵣ (12);
Pd_{5b}=Ps_{5b}−Pb_{5b} (13);
Pd_{5g}=Ps_{5g}−Pb_{5g} (14); and
Pd₅ᵣ=Ps₅ᵣ−Pb₅ᵣ (15).

The preferred difference information for a region of interest is the array of difference information (Pd) in each of the color planes for each of the N pixels in the region of interest. This difference information may be evaluated in many ways to yield meaningful information, such as by selecting the peak histogram value, as described herein. Alternatively, an algorithm for generating the difference spectral information sum may be represented by Equation (16), as follows:

$$Pd = {\sum }_{i = 1}^{N} {\sum }_{c = b , g , r} \vert {Ps}_{ic} - {Pb}_{ic} \vert ; \qquad ( 16 )$$

where Pd is the difference spectral information, i is an index to the pixel number, N is the total number of pixels in the region of interest, c is an index to the color plane, b is the blue color plane, g is the green color plane, r is the red color plane, Ps_{ic} is a digital representation of the intensity of the color plane denoted by c for the pixel number denoted by i corresponding to the source image, and Pb_{ic} is a digital representation of the intensity of the color plane denoted by c for the pixel number denoted by i corresponding to the background image.

Referring again to FIG. 3a, if it is determined that an offset is desired in step 70, the offset is added to the difference spectral information in step 72. The offset is used herein to describe that quantity that when added to the difference spectral information makes the resulting image more readily discemable to the user when displayed, such as by making the zero difference value appear as a grey color (R,G,B=128,128,128). It is preferable to apply the same offset to each of the R,G,B planes of the difference image, but different offset values can also be used for each plane.

Specifically, Equations (17) - (31) represent a preferred sequence for adding an offset to the difference spectral information for pixels 1-5 in step 70, as follows:
Pd_{1b}=Pd_{1b}+O_{b} (17);
Pd_{1g}=Pd_{1g}+O_{g} (18);
Pd₁ᵣ=Pd₁ᵣ+Oᵣ (19);
Pd_{2b}=Pd_{2b}+O_{b} (20);
Pd_{2g}=Pd_{2g}+O_{g} (21);
Pd₂ᵣ=Pd₂ᵣ+Oᵣ (22);
Pd_{3b}=Pd_{3b}+O_{b} (23);
Pd_{3g}=Pd_{3g}+O_{g} (24);
Pd₃ᵣ=Pd₃ᵣ+Oᵣ (25);
Pd_{4b}=Pd_{4b}+O_{b} (26);
Pd_{4g}=Pd_{4g}+O_{g} (27);
Pd₄ᵣ=Pd₄ᵣ+Oᵣ (28);
Pd_{5b}=Pd_{5b}+O_{b} (29);
Pd_{5g}=Pd_{5g}+O_{g} (30); and
Pd₅ᵣ=Pd₅ᵣ+Oᵣ (31);
where O_{b} represents the offset to be added to the blue color plane, O_{g} represents the offset to be added to the green color plane, and Oᵣ represents the offset to be added to the red color plane.

An algorithm for adding the offset to the difference spectral information sum may be represented by Equation (32), as follows:

$$Pd = {\sum }_{i = 1}^{N} {\sum }_{c = b , g , r} \vert {Pd}_{ic} - {O}_{c} \vert ; \qquad ( 32 )$$

where Pd is the difference spectral information, i is an index to the pixel number, N is the total number of pixels in the region of interest, c is an index to the color plane, b is the blue color plane, g is the green color plane, r is the red color plane, Pd_{ic} is a digital representation of the intensity of the color plane denoted by c for the pixel number denoted by i corresponding to the difference image, and O_{c} is the offset value corresponding to the color plane denoted by c.

If it is determined that gain is required in step 72, the difference spectral information is preferably multiplied by the desired gain factor in step 74. If the offset has been chosen not to be added to the difference spectral information in step 68, the process circumvents step 70 and proceeds to step 72. Likewise, if gain is not desired in step 72, the process circumvents step 74 and proceeds to step 76, as shown in FIG. 3b. The gain factor is used herein to amplify the difference spectral information so that it can more readily be viewed by the user on a display.

Specifically, Equations (33)-(47) represent a preferred sequence for multiplying the difference spectral information by the gain factor for pixels 1-5 in step 76, as follows:
Pd_{1b}=Pd_{1b}·G_{b} (33);
Pd_{1g}=Pd_{1g}·G_{g} (34);
Pd₁ᵣ=Pd₁ᵣ·Gᵣ (35);
Pd_{2b}=Pd_{2b}·G_{b} (36);
Pd_{2g}=Pd_{2g}·G_{g} (37);
Pd₂ᵣ=Pd₂ᵣ·Gᵣ (38);
Pd_{3b}=Pd_{3b}·G_{b} (39);
Pd_{3g}=Pd_{3g}·G_{g} (40);
Pd₃ᵣ=Pd₃ᵣ·Gᵣ (41);
Pd_{4b}=Pd_{4b}·G_{b} (42);
Pd_{4g}=Pd_{4g}·G_{g} (43);
Pd₄ᵣ=Pd₄ᵣ·Gᵣ (44);
Pd_{5b}=Pd_{5b}·G_{b} (45);
Pd_{5g}=Pd_{5g}·G_{g} (46); and
Pd₅ᵣ=Pd₅ᵣ·Gᵣ (47);
where G_{b} represents the offset to be added to the blue color plane, G_{g} represents the offset to be added to the green color plane, and Gᵣ represents the offset to be added to the red color plane.

An algorithm for multiplying the difference spectral information sum by the gain factor may be represented by Equation (48), as follows:

$$Pd = {\sum }_{i = 1}^{N} {\sum }_{c = b , g , r} {\vert {Pd}_{ic} \cdot {G}_{c} \vert}_{c} , \qquad ( 48 )$$

where Pd is the difference spectral information, i is an index for the pixel number, N is a total number of pixels in the region of interest, c is an index to the color plane, b is the blue color plane, g is the green color plane, r is the red color plane, Pd_{ic} is a digital representation of the intensity of the color plane denoted by c for the pixel number denoted by i corresponding to the difference image, and G_{c} is the gain factor corresponding to the color plane denoted by c.

If a difference threshold is desired in step 78, a threshold function is preferably applied to the difference spectral information in step 80. The threshold function essentially compares difference spectral information associated with each of the red, green, and blue planes for each pixel to one or more desired threshold values or ranges. If the spectral information is less than or greater than the threshold or within a threshold range, this particular portion of the difference spectral information is preferably not shown on the display or assigned a default or predetermined value. Additional details concerning the threshold function are shown in FIG. 5, which is described below.

In step 82 of FIG. 3b, the process preferably generates a histogram representing pixel intensity as a function of the quantity of pixels having a particular intensity for each of the red, green, and blue color planes. If the threshold function has been applied, the histogram is preferably limited to a region of interest determined by the desired threshold value or range. A graph is displayed to the user in step 84 with pixel intensity as the y-axis and the quantity of pixels having a particular intensity as the x-axis. The pixel information for each of the red, green, and blue color planes is preferably displayed as a red line, a green line, and a blue line, respectively, on the graph.

Peaks in the histogram are then preferably determined for each of the red, green, and blue color planes in step 86. The peak information is preferably displayed as an additional graph having pixel intensity as the y-axis and time as the x-axis with red, green, and blue lines representing each of the red, green, and blue color planes in step 88.

In step 90, the background spectral image and a processed spectral image are preferably displayed to the user. The processed spectral image is preferably the difference spectral information as optionally modified by the offset, gain, and threshold, values. The processed spectral image may also result from overlaying or superimposing the difference spectral information on one or more background spectral images.

The analog information obtained from the potentiostat in step 64 is preferably displayed in graphical form in step 92. The analog information is preferably displayed as a graph of voltage or current on the y-axis and the sample number on the x-axis. Since samples of the analog information are preferably obtained consecutively over time, the analog information is essentially displayed as a function of time. The process then preferably determines whether a halt is indicated in step 94 and either returns to step 54 to re-execute the process or ends in step 96.

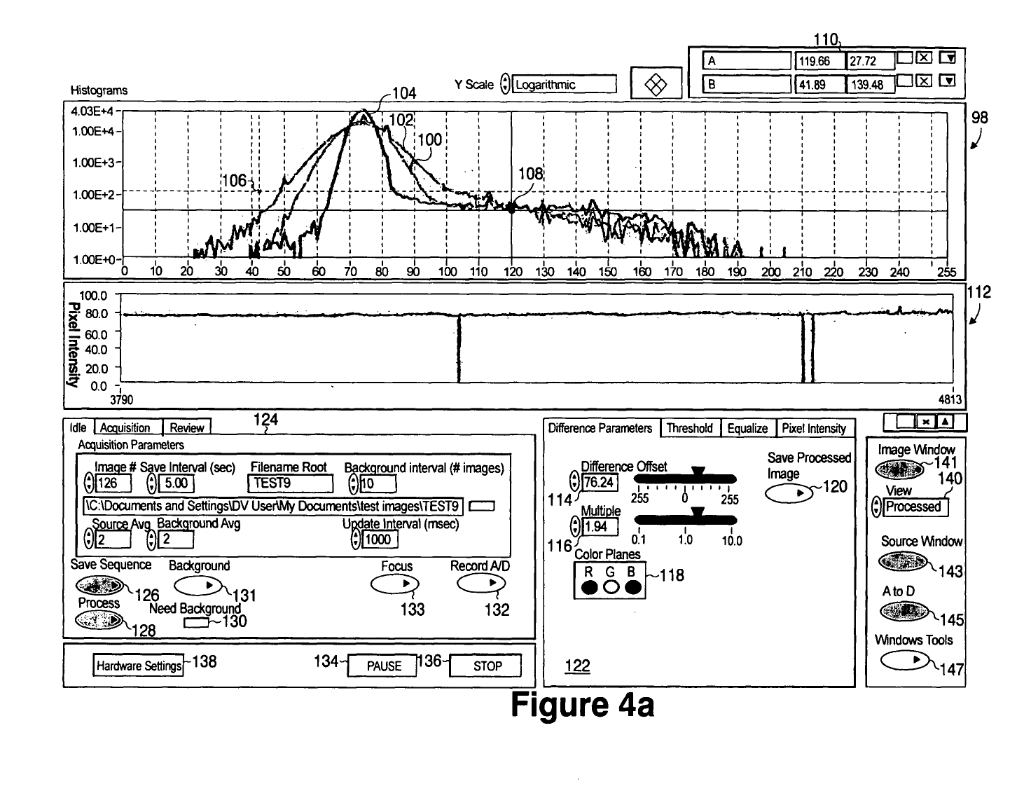

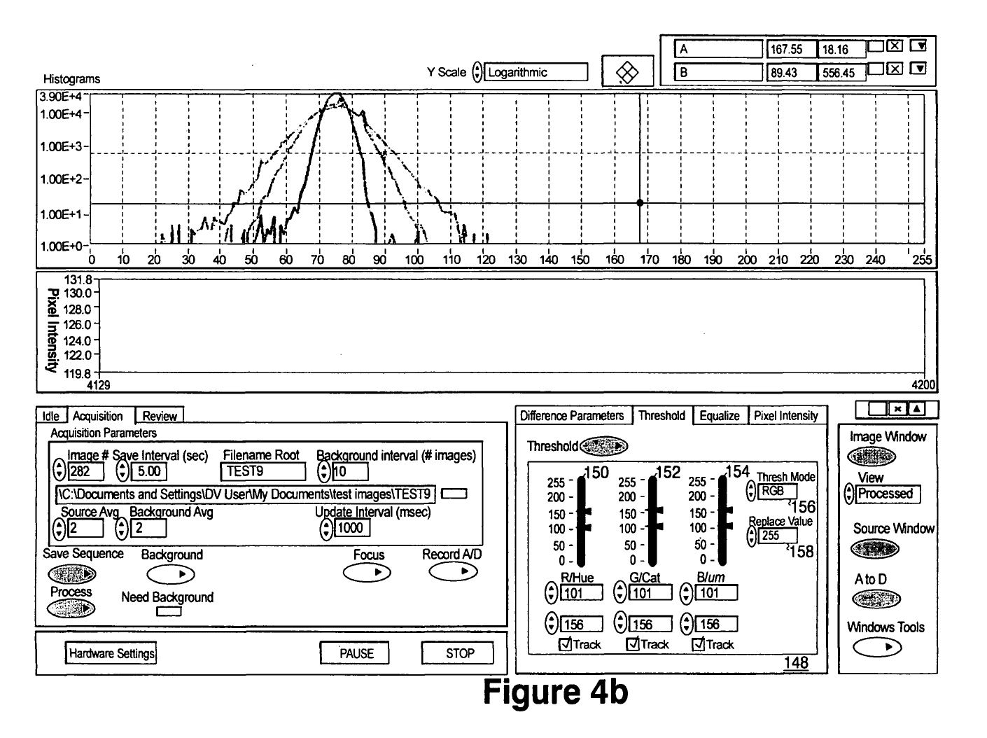

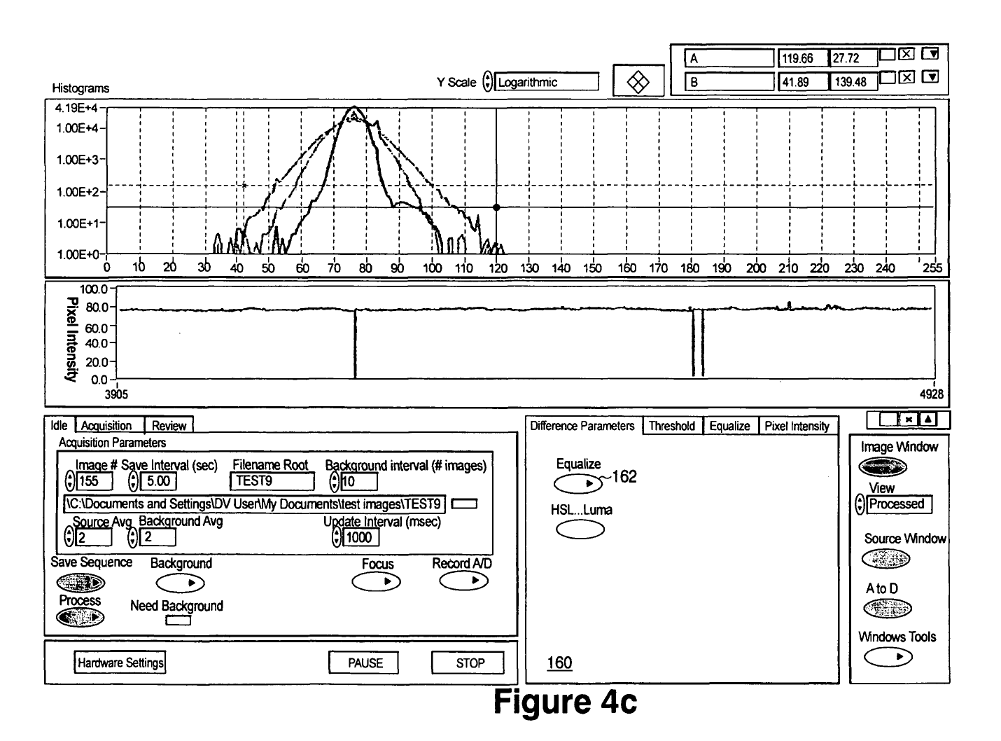

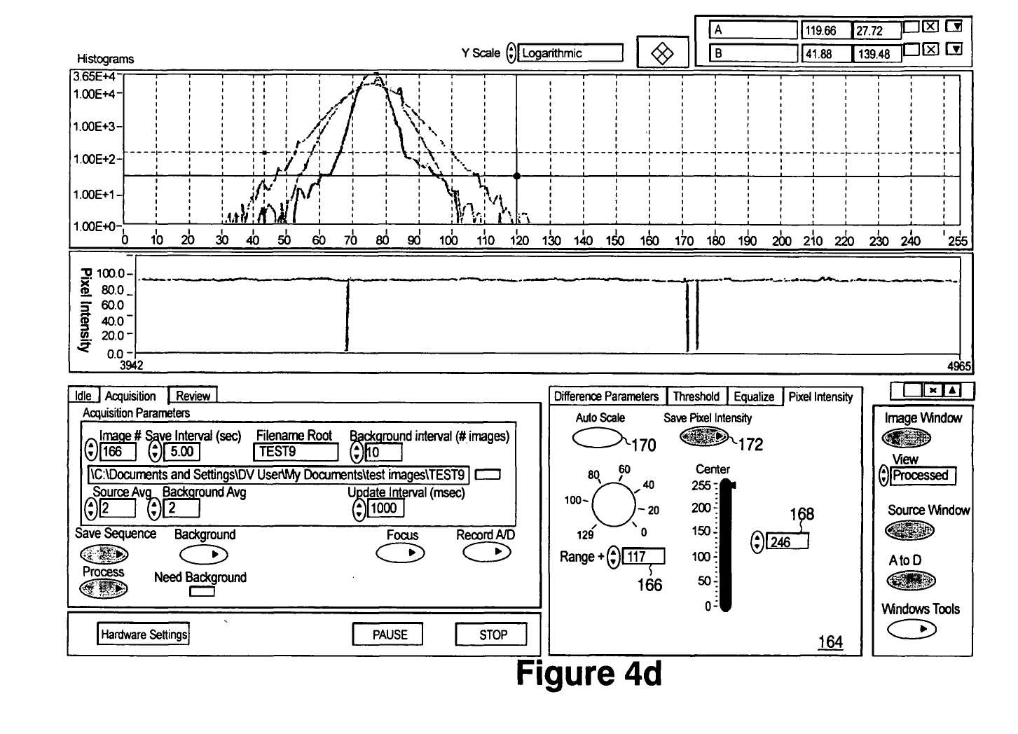

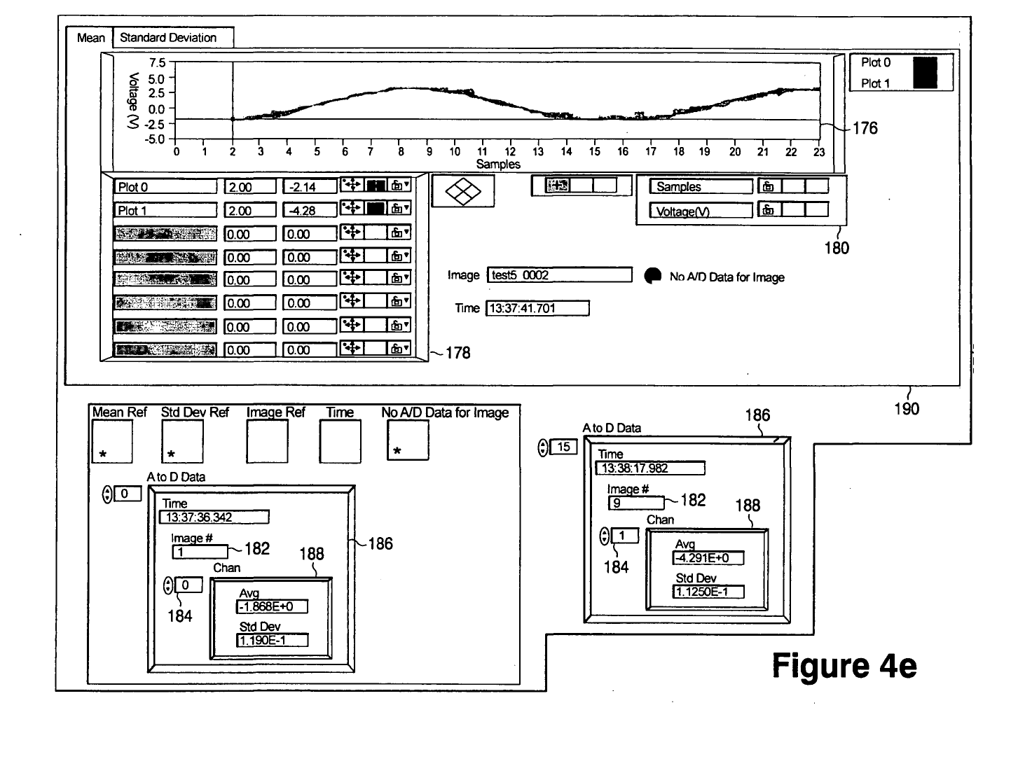

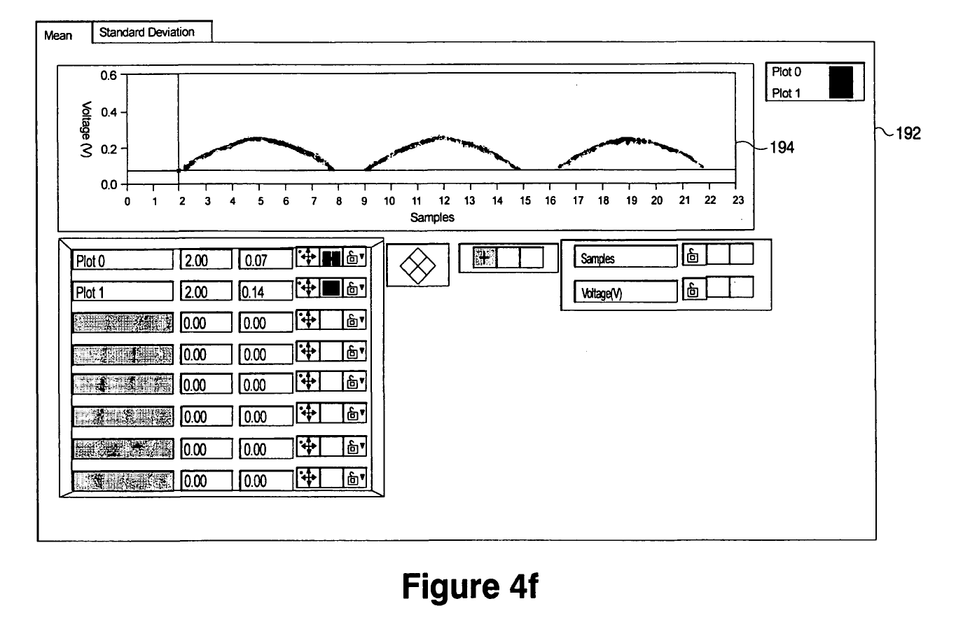

FIGS. 4a-4f show representative computer displays that enable the user to interface with the process in accordance with the present invention. FIG. 4a shows the histogram 98 of pixel intensity as a function of a quantity of pixels having a particular intensity. As described above, the histogram preferably includes a red line 100, blue line 102, and a green line 104 that represent digital information corresponding to each of the red, blue, and green color planes, respectively.

Cursors 106, 108 provide x and y coordinates corresponding to their location on the histogram so that the user can assign specific values to selected portions of the histogram. The x and y values for each of the cursors 106, 108 is preferably provided in a display block 110. For instance, as shown in FIG. 4a, cursor 108 has an x value of 119.66 and a y value of 27.72, as indicated in block 110.

FIG. 4a also preferably shows a graph of histogram peak intensities 112 as a function of time for each of the red, green, and blue color planes. Thus, as with the histogram 98, the histogram peak graph 112 preferably includes three lines, each of which represents one of the red, green, and blue color planes.

The lower portion of the display is preferably used to input user-defined parameters. For instance, the user is preferably able to select the desired offset in field 114 and the desired gain factor or multiplier in field 116. The offset and gain factors preferably correspond to one or more of the red, green, and blue color planes, which are selected in field 118.

The user is preferably able to save the processed image by selecting field 120. The parameters discussed above are preferably included within a difference parameter field 122, which is one of a plurality of tab selectable fields within the same general field on the display.

In an acquisition parameter field 124, the user-selectable fields include the filename to which the saved images are assigned and the number of spectral images that are to be obtained before acquiring a new background image. In addition, the user is preferably able to select the number of source images and background images over which the corresponding spectral information is averaged, as well as the length of an update interval, which is the interval between acquisitions of different source images.

The acquisition parameters are preferably saved by selecting a save sequence field 126 and processing is initiated by selecting a process field 128. A new background spectral image is preferably acquired in response to selecting a background field 130 and analog information from the potentiostat is preferably obtained in response to selecting a record A/D field 132. A new background image is preferably acquired by selecting the background field 131 and the displayed images are focused by selecting a focus field 133. Processing is preferably paused or stopped by selecting fields 134 and 136, respectively. Additional hardware settings, such as buffer sizes and camera specifications may be accessed through a hardware settings field 138.

In the bottom rightmost portion of the display, the user is preferably able to select one or more images to be displayed, that is, one of the background, processed, or source images, by selecting the desired image in a view field 140. The user is also preferably able to show or hide the image or source display windows by selecting fields 141 or 143, respectively. The user is also preferably able to turn the analog data acquisition on or off by selecting field 145 and to show or hide window tools for defining a region of interest by selecting field 147.

FIG. 4b is substantially similar to FIG. 4a, except that a threshold field 148 has been selected rather than the difference parameters field 122 shown in FIG. 4a. The threshold field 148 preferably enables the user to select threshold ranges for each of the red, green, and blue color planes, by selecting the appropriate values in fields 150, 152, 154, respectively. A threshold mode is selected in field 156, which preferably determines those color planes subject to the threshold function. A value to be substituted for those portions of the image that are outside of the threshold range is preferably provided by the user in field 158.

FIG. 4c is substantially similar to FIG. 4a, except that an equalize field 160 has been chosen rather than the difference parameters field 122. By selecting an equalize field 162, the user is essentially able to spread the spectral information over a broader region along the x-axis on the display to enable finer details to be more readily discernable by the user.

FIG. 4d is substantially similar to FIG. 4a, except that a pixel intensity field is shown rather than the difference parameters field 122 shown in FIG. 4a. The user preferably selects, in field 166, a range of pixel intensity for displaying, as well as a center of the displayed pixel intensity at field 168. Alternately, the user may select an auto scale field 170, which essentially formats the displayed pixel intensity to most efficiently use the entire display field in accordance with the spectral information in the queue. Pixel intensity is preferable saved by selecting field 172.

By selecting the analog-to-digital field 145 shown in FIG. 4a, a mean value of the analog information provided by the potentiostat is preferably displayed to the user on an analog display field 190 shown in FIG. 4e. A graphical display 176 of voltage as a function of sample number or time is displayed with at least two lines having different colors representing plot 0 and plot 1. The differently colored plots preferably represent different signals used for excitation of the potential stat, such as triangular or sinusoidal signals, or the current response of the potential stat.

Cursors are preferably provided on the graphical display 176, and the x and y coordinates associated with these cursors are provided in field 178. Alternatively, a graph of current as a function of sample number or time may be displayed in field 176 by selecting an alternative value in field 180. Information concerning a particular image number, as selected in field 182, and a channel number, as selected in field 184, is preferably provided in field 186, such as the average value and standard deviation for the analog information shown in field 188.

FIG. 4f is substantially similar to FIG. 4e, except that a standard deviation field 192 is shown rather than the mean field 190. The graph 194 preferably shows the standard deviation of voltage as a function of sample number or time for one or more excitation signals or plots, which are preferably represented in different colors on the graph 194.

FIG. 5 is a flowchart that provides additional details concerning the threshold function performed in step 80 in FIG. 3b. In step 196, which follows step 78 shown in FIG. 3a, the index I, which denotes the current pixel number, is preferably initialized to one and the index c, which denotes the current color plane, is preferably initialized to blue. The digital representation for the difference spectral information Pd_{ic} associated with the current pixel number and current color plane, is then preferably compared to an upper threshold Tu_{c} and a lower threshold Tl_{c} associated with the current color plane in step 198.

If the difference spectral information is not within the threshold range, the 10 difference spectral information is preferably overwritten with a default or predetermined value representing, for instance, the intensity of a blank background in step 200. If the difference spectral information is within the threshold range, index i is preferably incremented in step 202. If index i is not greater than the total number of pixels N in step 204, the routine preferably returns to step 198.

If index i is greater than N, index c is not currently green in step 206, and index c in not currently red in step 210, index i is preferably initialized to 1, index c is set to green in step 208, and the routine returns to step 198. If index c is determined to be green in step 206, then index i is preferably initialized to 1, index c is set to red in step 212, and the routine returns to step 198. If index c was red in step 210 the routine continues with step 82, as shown in FIG. 3b.

A pH sensitive color indicator is preferably placed in a solution that is on top of a sample to be studied. In some cases, it is desirable to include a gelling agent in the solution to slow down bulk transport so that larger gradients may be built up. Alternative types of indicator dyes may be used to monitor other electrochemically significant quantities. For example, there are a wide variety of chemical spot tests (see Andrew Holmes, Rapid Spot Testing of Metals, Alloys and Coatings, Metal Finishing Information Services Ltd. and ASM International, pp. ______ (2002) which is incorporated herein by reference) that can be used to test for the presence of specific chemicals in a solution, such as lead, iron, and hydrogen ions (pH). In addition, fluorescent indicators exist that respond to metal ions, such as zinc, and fluorescent indicators exist that respond to a potential difference across a membrane.

If a polychromatic light source, such as a tungsten-halogen bulb, is used to illuminate the sample, the reflected light preferably includes spectral information regarding the molecular absorbance of the indicator dye in the solution. Spectrally filtered light is used to illuminate the sample with fluorescent markers and the spectral information from the fluorescent emissions may be monitored. In either case, a color image digitizer is preferably used to capture spectral information from the resulting light.

Monochromatic light is preferably used to measure spectral absorbance or fluorescence information at a fixed wavelength when absorption or fluorescence at only one wavelength is necessary for spectral quantification. If monochromatic illumination is used, then a monochromatic image digitizer may be used. In the case of fluorescence detection, it is generally preferably to use an interference filter in front of the image digitizer to block the illumination light and pass the fluorescence emission.

Correlation between the measured spectral information and an electrochemically significant measurement is important. The following example demonstrates application of this technique with a pH indicator dye having a pH range of 4-10 placed in a solution over a metal sample. A gelling agent is used to slow down bulk transport so that larger gradients may be observed for longer periods of time. The sample is illuminated from above with a tungsten-halogen lamp without the use of spectral filters. A color video camera with a low magnification lens is preferably used to acquire an RGB encoded image.

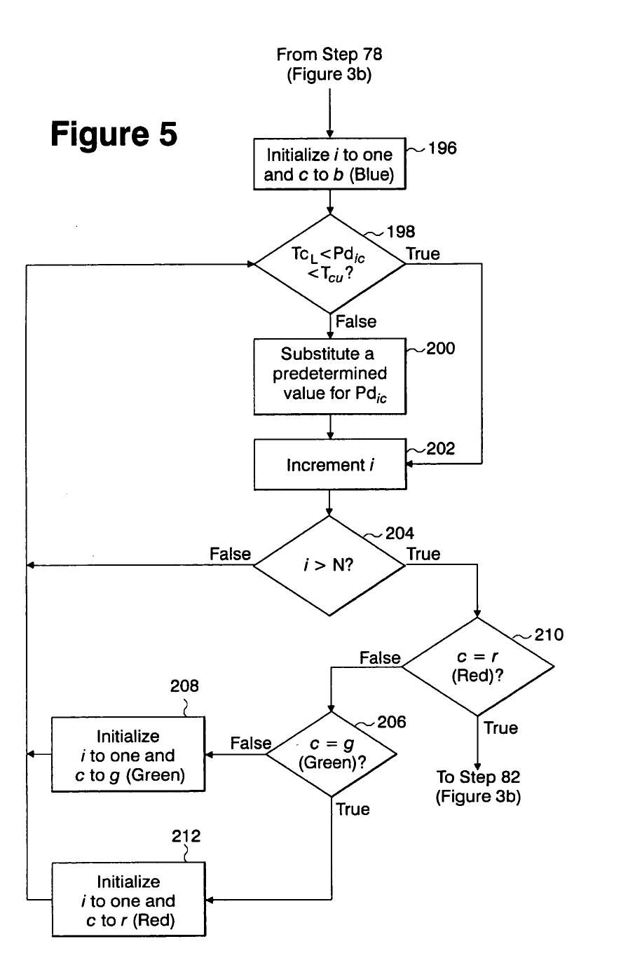

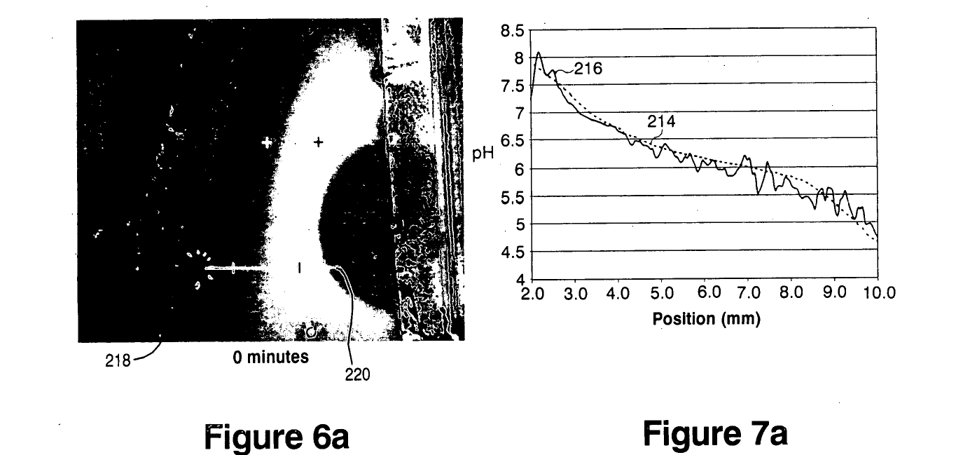

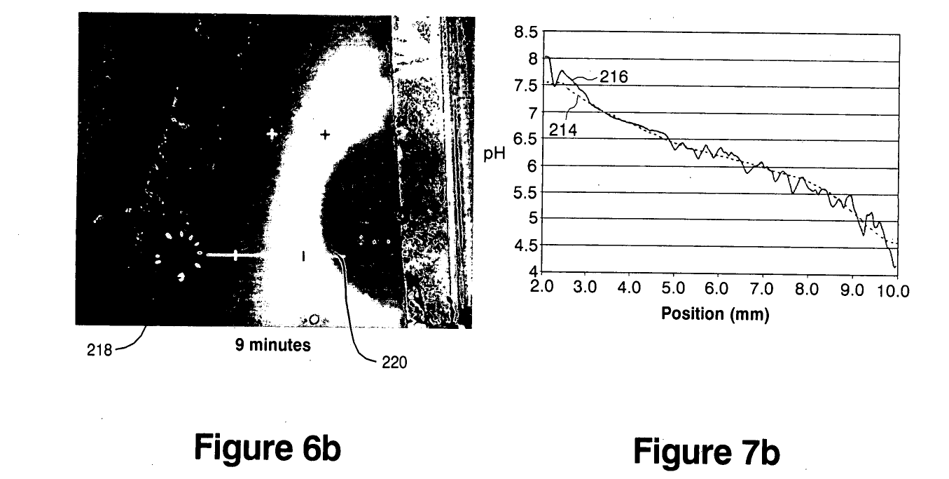

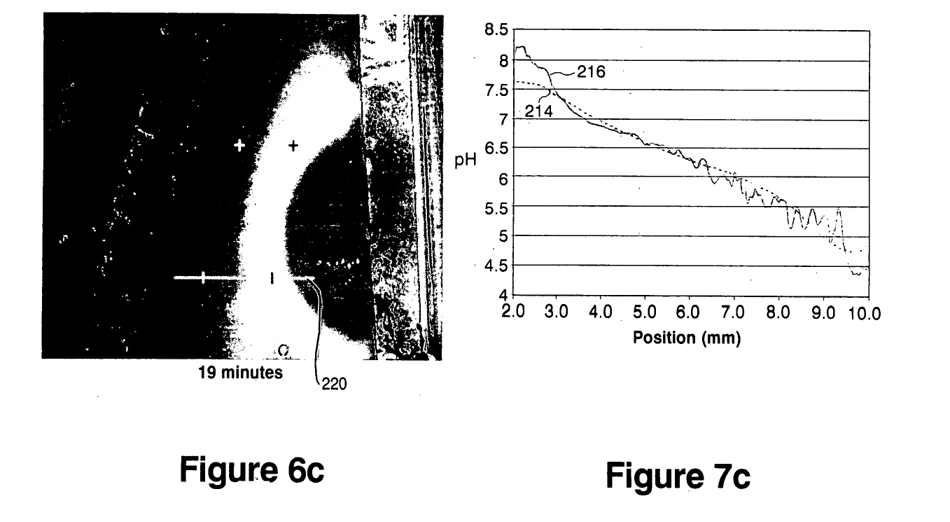

A time sequence of three images is shown in FIGS. 6a-6c taken at 0, 9, and 19 minutes, respectively. To the right of each image is a corresponding graph, FIGS. 7a-7c, showing the pH profile taken along an 8 mm line measured with a tungsten microelectrode, as indicated by a dashed line 214, and the spectral method described below, as indicated by a solid line 216.

A white star-burst 218 in the lower left of the first two images, FIGS. 6a and 6b, represents a tungsten microelectrode immersed in the gelled solution to measure the localized pH based on the electrochemical potential of the electrode tip with respect to a stable reference electrode. The microelectrode is calibrated in a known buffer solution, and stepped at regular intervals of 0.116 mm across the gelled solution to estimate the pH gradient shown by the dashed lines 214 in FIGS. 7a-7c. The path along which pH is measured by the microelectrode is shown as a white line 220 in each of FIGS. 6a-6c. The time required to scan an 8 mm path with this resolution is about 400 seconds.

The spectral content of the image data along the probe path is preferably calibrated from the pH values obtained by the tungsten microelectrode using the procedure in accordance with the present invention. The pH values along the probe path are then preferably calculated from the spectral information in the image along this path and plotted as a solid line in the charts shown in FIGS. 7a-7c. The spectral values are preferably obtained from RGB values along a single pixel line, and the RGB values in this line are smoothed by averaging the value for each pixel with the value of its nearest neighbor pixels to the right and left.

Each pixel represents a physical dimension of 0.057 mm on the sample. The time required to acquire pixel data for the full image is less than 17 milliseconds. The data from the line along the probe path, which is analyzed to generate the charts in FIGS. 7a-7c, may be acquired in less than 10 microseconds (140 pixels at a 20 MHz clock rate). This is greater than seven orders of magnitude faster than the acquisition rate using the microelectrode.

The spectral content of the reflected light is preferably detected by the color camera and determined as follows:
1. Each pixel in the image is preferably digitized to obtain an RGB value;
2. The RGB value is preferably converted to an rgb tristimulus value, as follows:
   r=R/(R+G+B) (49)
   g=G/(R+G+B) (50)
   b=B/(R+G+B) (51).

For example, the digitized color value RGB=(106,137,73) becomes the tristimulus value rgb=(0.335,0.434,0.231). The tristimulus value normalizes the color content of the digitized value against intensity to facilitate color matching calculations.
3. The rgb tristimulus value is preferably converted to a Spectral Power Distribution SPD using the CIE 1931 color matching functions r, g, b described in Wyszecki, Gunther, and Stiles, Color Science: Concepts and Methods, Quantitative Data and Formulae, Second Edition, John Wiley & Sons, Inc., New York, 2000, pp.750-751, the relevant portions of which are incorporated herein by reference:
   SPD=r r+g g+b b (52).

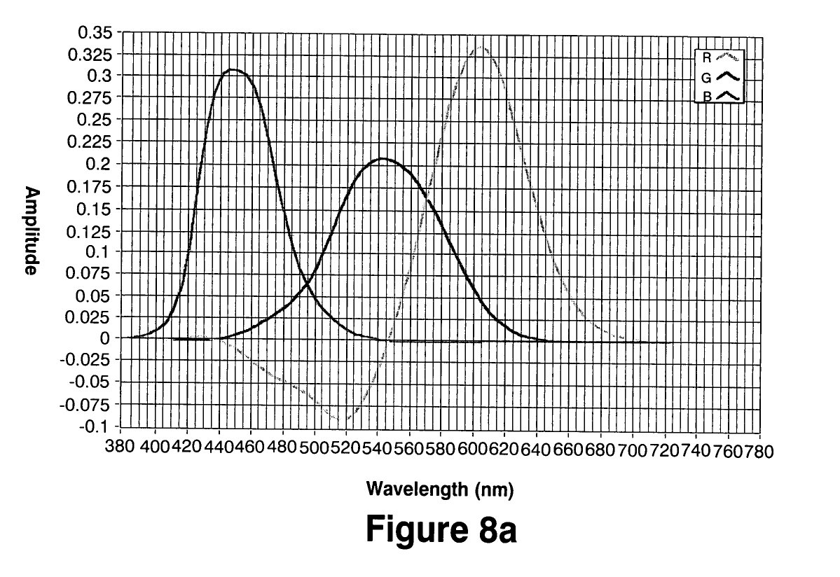

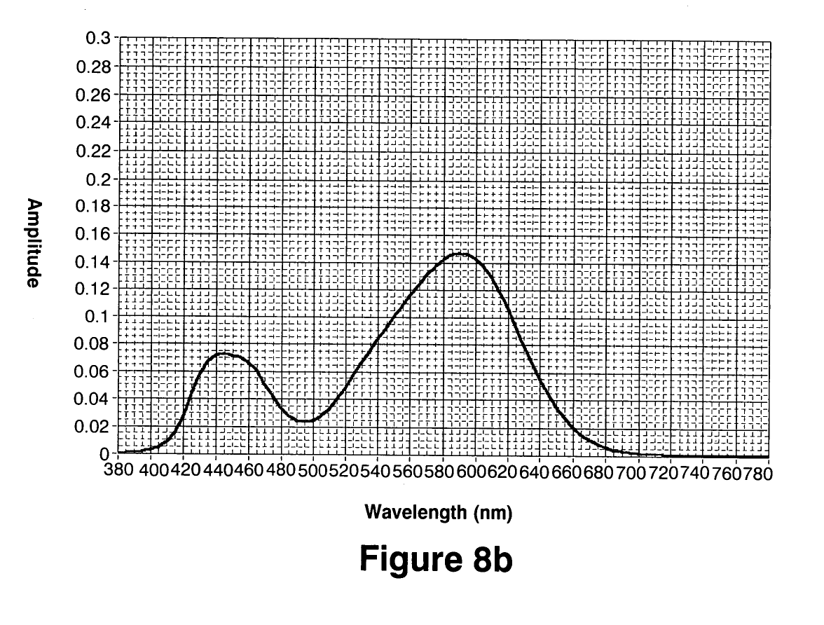

The rgb color matching functions are shown in FIG. 8a and an example of the SPD for the RGB value (106,137,73) is shown in FIG. 8b. The SPD calculated in this manner is technically a metamer, which means that the human eye will perceive it to be the same color as the light from the sample, while, in fact, the light from the sample may actually have a different SPD. As will be seen from the following results, this does not prevent a meaningful determination of pH based on the calculated SPD.
4. The SPD for each pixel in the path of the tungsten microelectrode is calculated and transmission peaks are observed near 450 nm and 600 nm in each SPD throughout the pH range of ˜7.6 to ˜4.6 along the tungsten microelectrode path. This agrees with the expectation that high pH values produce a blue color and low pH values produce a red color. pH may be accurately estimated based on calibrations involving absorption peaks rather than transmission peaks. In the present invention, a multivariable function is preferably used to map RGB color values to a pH value.

In one embodiment of the present invention, the product of the SPD transmission peaks calculated, as described above, at two wavelengths provides a parameter that is preferably used to fit a curve for calculating pH.

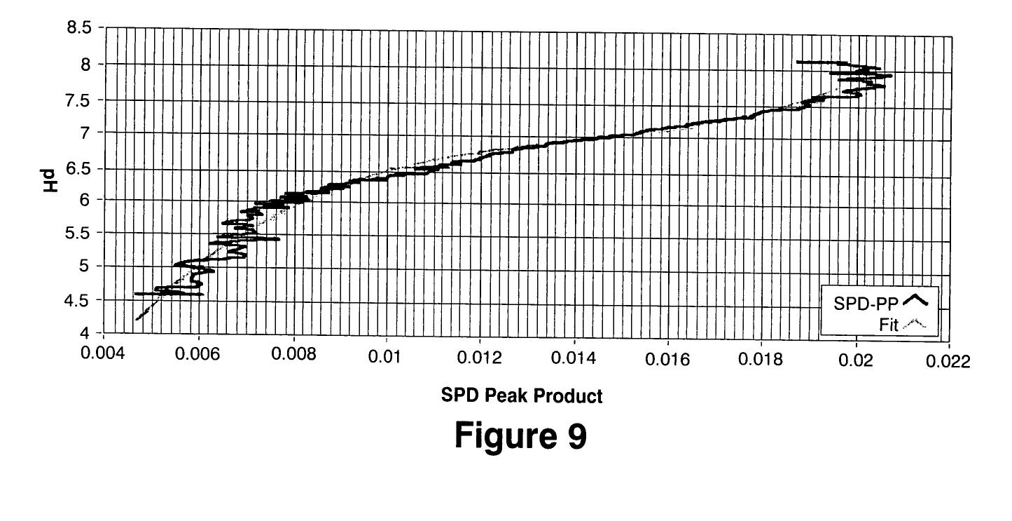

In the case shown in FIG. 9, which shows a curve fit for pH as a function of SPD peak product at 450 and 600 nm, the SPD peak product x is preferably calculated using the following equation:
x=SPD₄₅₀·SPD₆₀₀ (53),
and the curve fit for calculating pH from the SPD peak product x is expressed as the following:
pH=−8.531E−1x³+1.503E+3x²+−1.013E+5x+2.390E+6 (54).

The SPD peak product is not necessarily the preferred parameter to use for calculating pH since this parameter may not perform well above a pH of 7.5 or below a pH of 5.5. The performance of this parameter at these extremes is due in part to the intrinsic spectral characteristics of the illumination source, camera, sample, and solution.

For example, the RGB values used to generate the SPD peak product for pH values above 7.3 were near the noise level of the camera, which represents very dark colors. In addition, it was observed in the data set described above that the red values from the camera were saturated for most of the pH values below 6, which resulted in a loss of dynamic range and accuracy for the SPD peaks. Even under these conditions, close agreement was obtained between the pH values from the tungsten electrode and the pH values calculated using the SPD peak product parameter.

The preferred parameter for calculating pH depends on a number of factors including, but not limited to the spectral output of the illumination source, the spectral sensitivity of the imaging device, the emissivity of the sample being observed, and the spectral transmission characteristics of the indicator and the solution being used.

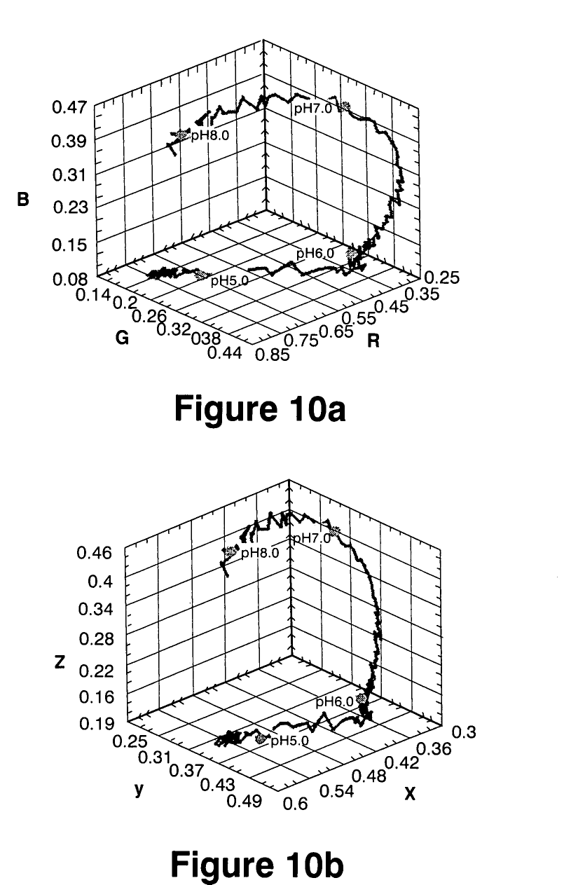

Another example of a method for mapping RGB values to pH in accordance with the present invention will now be described. Measurement of RGB values obtained with a video camera are transformed into rgb tristimulus values and plotted as a function of pH, as measured with the tungsten microelectrode. Alternatively, the RGB values may be transformed into a different color space, for example, the CIE 1931 X,Y,Z space, as described in Wyszecki, Gunther, and Stiles, Color Science: Concepts and Methods, Quantitative Data and Formulae, Second Edition, John Wiley & Sons, Inc., New York, 2000, p. 139, the relevant portions of which are incorporated herein by reference. Examples of these two scenarios are provided in FIGS. 10a and 10b, which show plots of pH as a function of measured color value in RGB space, as shown in FIG. 10a, and X,Y,Z space, as shown in FIG. 10b.

The color space values, referred to here in general as (a,b,c), define a line in three-dimensional space such that evaluation of a function f(a,b,c) produces a pH value, that is, pH=f(a,b,c). The difficulties of this approach include finding the form of the equation f(x) that will fit the multivariable data obtained in the calibration process, and defining the range of values for which the fitted curve can be evaluated, that is, what to do if the dependent coordinates are not in the range of values for which the curve is defined during calibration.

It may be preferable to adjust the illumination level and camera shutter speed so that none of the pixels are saturated at any point during the acquisition. Once the illumination level has been set, the camera is preferably white balanced. These precautions ensure that the camera is capable of obtaining the widest dynamic range of spectral information during the experiment.

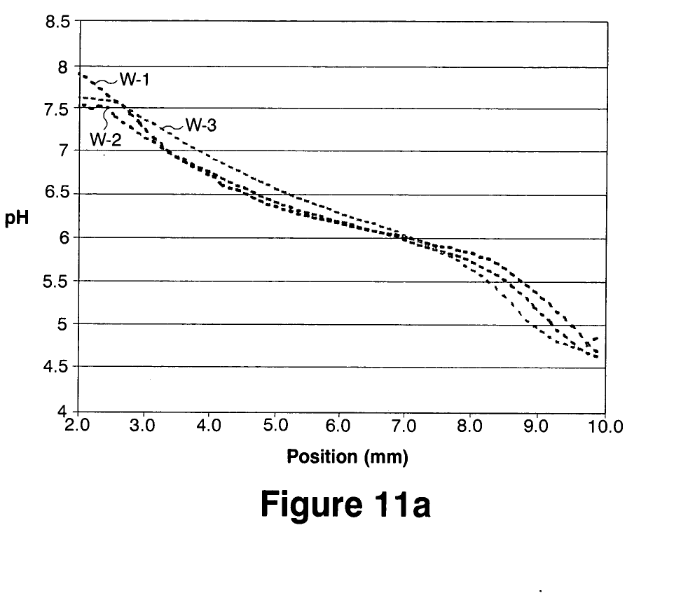

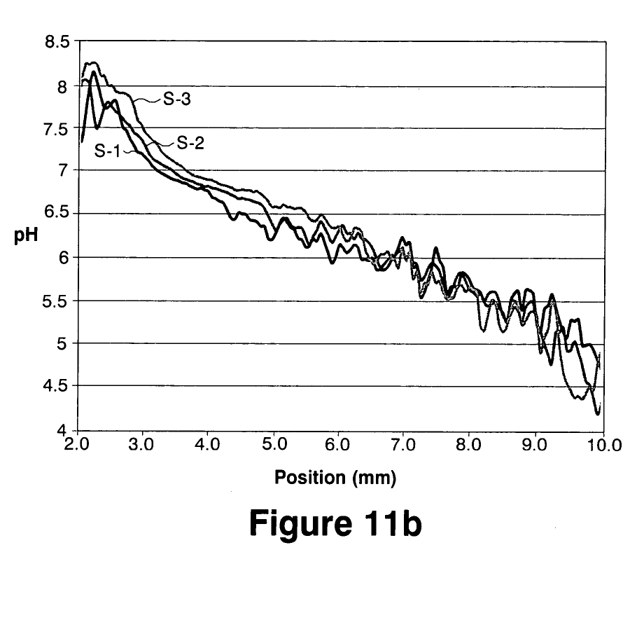

A comparison of pH gradient data obtained from three subsequent scans of the tungsten microelectrode is shown in FIG. 11a and compared with the pH gradient data along the same path calculated from pixel lines in three images acquired near the start of each microelectrode scan. The gradients become steeper with each subsequent microelectrode scan, a pattern which can be seen in both pH data measured with the tungsten microelectrode in FIG. 11a and the pH data measured with the spectral information obtained with a color video camera shown in FIG. 11b.

Thus, the method formed in accordance with the present invention provides the capability of obtaining a quantitative measurement of pH from a digitized image. In essence, the method provides a very tightly packed array of pH microelectrodes operating at very high speed. It is possible to select a region of interest as small as a single pixel, and monitor its pH as a function of time. This permits a highly localized measurement to be made.

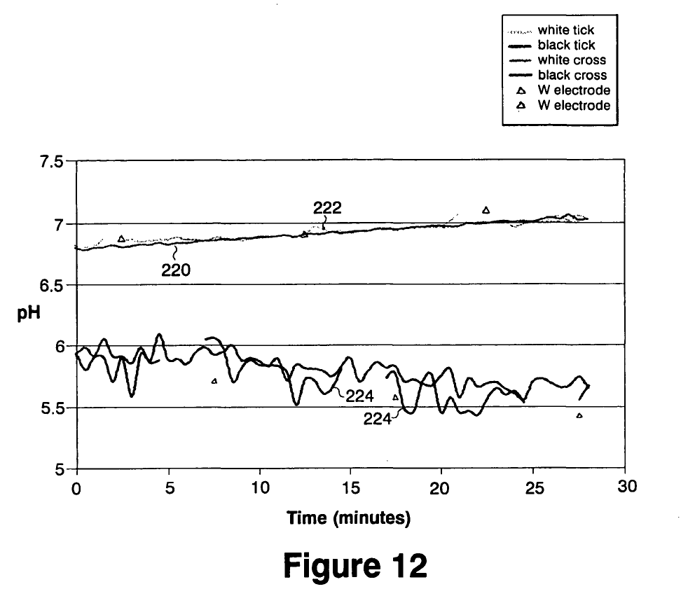

FIG. 12 shows pH values at selected points as a function of time measured with the tungsten microelectrode at curves 220 and 222. Data omitted from the curves 224 in FIG. 12, which shows the spectral method in which pH is determined from the source image RGB color values, was acquired while the tungsten microelectrode obscured the pixel.

The pH as a function of time for two additional points, which were not along the probe path but had a similar initial color, is plotted for comparison. This shows the type of data that can be obtained if there is no scanning microelectrode obstructing the image digitizer. The pH measurements as a function of time correspond to a roughly 60×60 micron area that is monitored continuously without the use of a microelectrode.

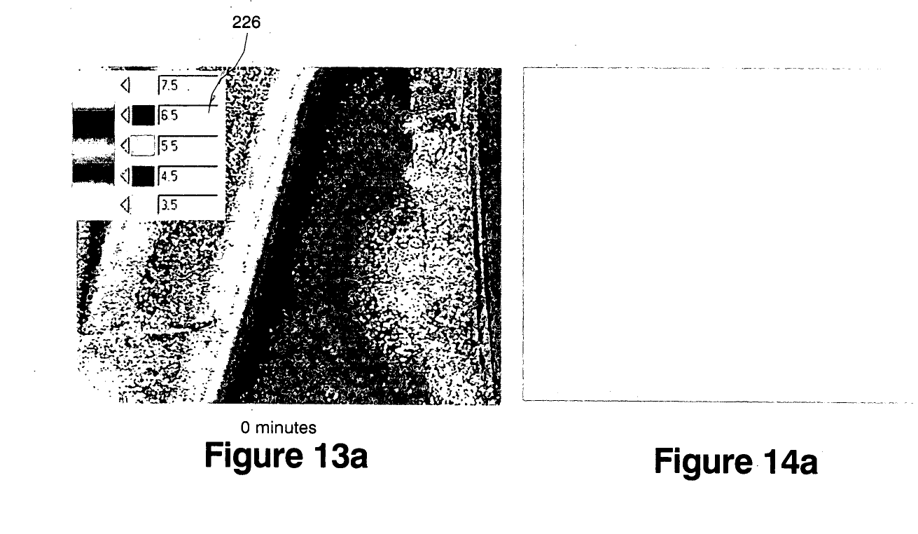

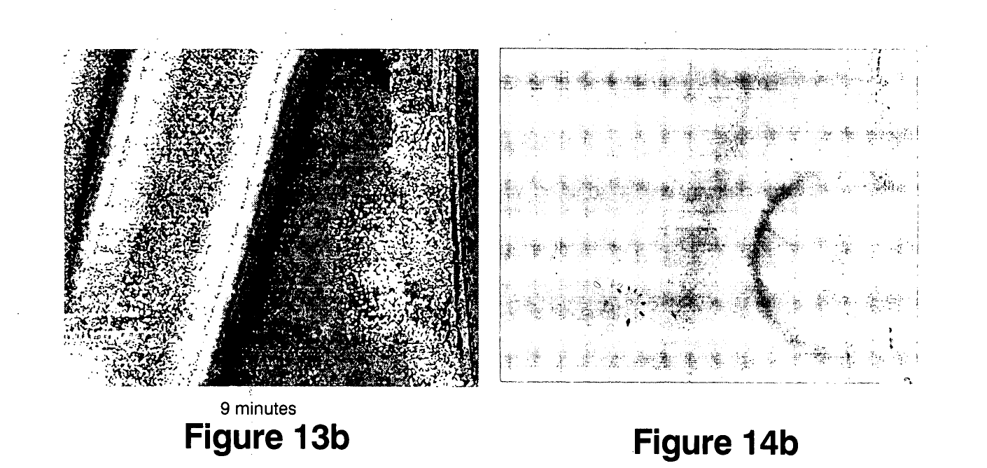

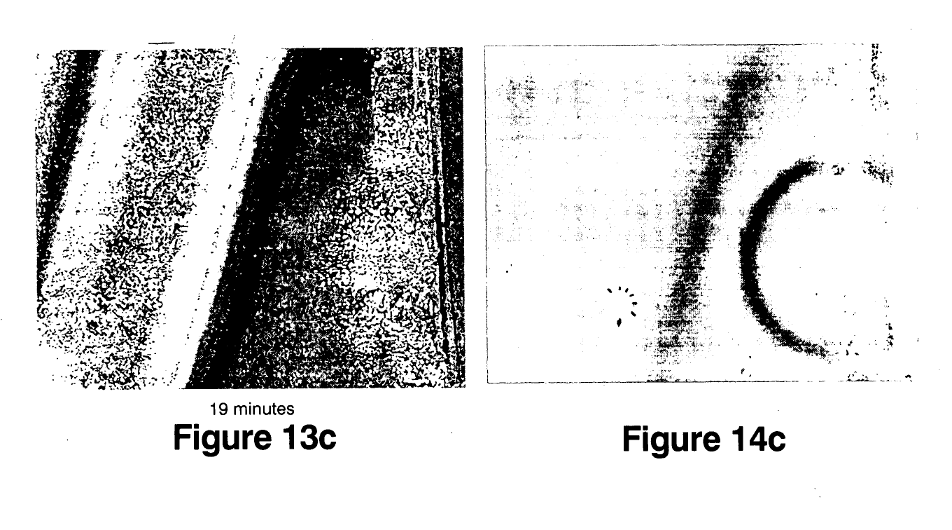

Since it is possible to analyze each pixel in the image to generate a pH value from the RGB value, it is possible to transform each pixel in an acquired image into a pH value. The result of applying this method to the images in FIGS. 6a-6c is provided in FIGS. 13a-13c, which show a time sequence of pH maps calculated from RGB values in the source image at 0, 9, and 19 minutes, respectively.

The white areas represent locations where the SPD Peak Product parameter is out of range for calculating the pH value. FIGS. 14a-14c show enhanced difference images referenced to the image in FIG. 14a. A color scale 226 in FIG. 13a shows the pH color codes used in FIGS. 13a-13c.

Each pH value in FIGS. 14a-14c requires calculations made with floating point buffers to obtain a reasonably accurate value. Each calculation includes 1 add and 3 divides to go from RGB to rgb, 6 multiplies and four adds followed by a multiply to produce an SPD peak product value, followed by 9 multiplies and three adds to obtain a pH value. While conventional computers perform these operations quite rapidly, another method may be used to more rapidly estimate pH from a difference image.

The present invention is able to rapidly detect changes in a field of view by looking at differences between a current digitized image and a reference digitized image, and translate those differences into electrochemically important quantities. The RGB difference images with respect to the 0 minute image (FIG. 13a, multiplier=0.5, offset=128) are shown to the right of the pH image in FIG. 14a.

Although the enhanced RGB difference image simplifies the identification of regions where there are changes in pH, estimating pH changes requires the determination of a difference image based on rgb tristimulus values. Equation (53) has the general form pH=f(x), and thus an estimate of the change in pH may be obtained as follows:
ΔpH=f′(x)Δx (55).

For example, if x=SPD₄₅₀ * SPD₆₀₀ as in Equation (53), then f′(x) is preferably obtained from Equation (54) as follows:
f′(x)=−2.5593x²+3.006E+3x+−1.013E+5 (56).

This function is preferably calculated once for the reference image. Subsequent changes in pH are preferably determined from the difference image provided Δx can be calculated from the RGB values in the difference image. Evaluating Equation (53) for the reference image yields the following:
x=SPD_{450,ref}*SPD_{600,ref} (57).

In general, subsequent images preferably have a different Spectral Power Distribution peak product, which can be expressed follows:
x+Δx=SPD₄₅₀*SPD₆₀₀ (58).

Subtracting Equations (57) from (58) yields the following expression for Δx:
Δx=SPD₄₅₀* SPD₆₀₀−SPD_{450,ref}*SPD_{600,ref} (59).

The values SPD_{450,diff} and SPD_{600,diff} from the Spectral Power Distributions calculated using the rgb tristimulus values associated with the difference image are as follows:
SPD_{450,diff}=(SPD₄₅₀−SPD_{450,ref}) (60)
SPD_{600,diff}=(SPD₆₀₀−SPD_{600,ref}) (61),

The method for obtaining tristimulus values for the difference image is to transform the source image into tristimulus rgb values using Equations (49), (50), and (51), and to take the difference between the tristimulus image and the tristimulus reference image to determine the SPD_{450,diff} and SPD_{600,diff} values using Equation (52). Equations (60) and (61) can be solved for SPD₄₅₀ and SPD₆₀₀ and substituted into Equation (59). The result is as follows:
Δx=SPD_{450,diff}*SPD_{600,ref}+SPD_{600,diff}*SPD_{450,ref}+SPD_{450,diff}*SPD_{600,diff} (62).

Substituting this value, which requires 3 multiplies and two adds, into Equation (56) yields a value for ΔpH with one additional multiplication. Thus, the 9 multiplies and three adds required to obtain a pH value from the source RGB values may be replaced by 3 subtractions (to get the rgb difference value), 4 multiplies, and two adds to estimate a change in pH relative to a reference image, provided the f(x_{ref}) values in Equation (57) for the reference image are calculated in advance and stored in a floating point buffer.

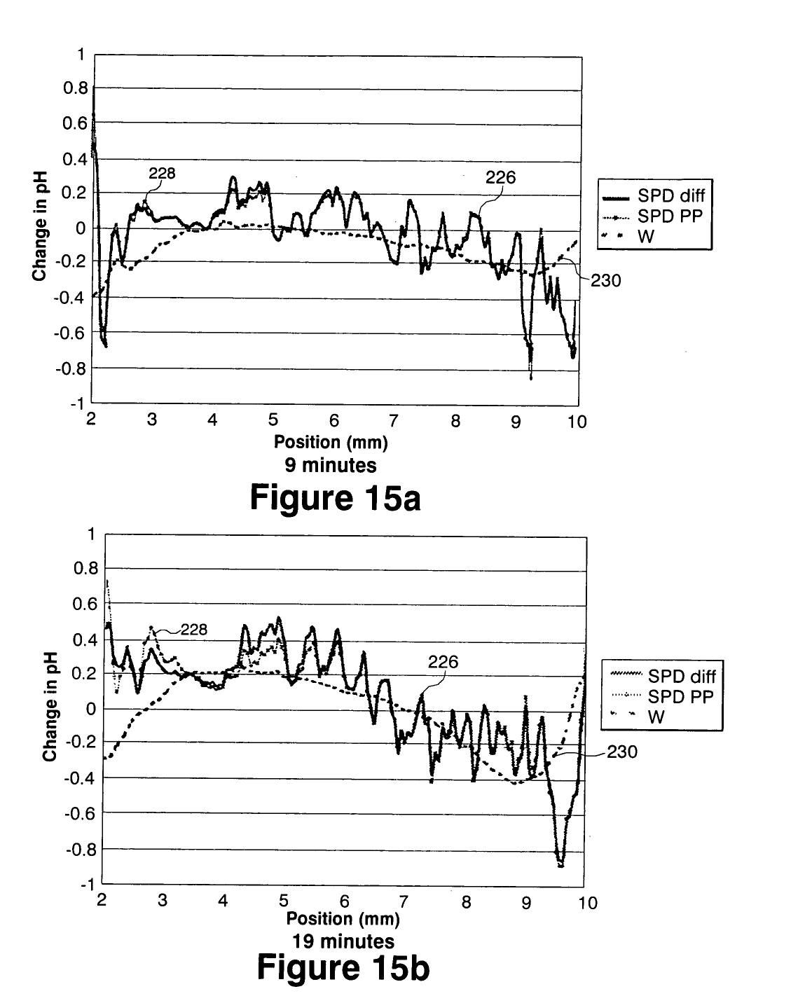

FIGS. 15a and 15b compare this method of estimating pH changes, as shown by a thick solid line 226, with two other methods at 9 and 19 minutes, respectively. The profile is taken along the same line shown in the images of FIGS. 6a-6c. The first comparison is made by transforming the source image RGB values into pH units, as described above, and then subtracting the pH values for the current image from the pH values for the reference image. Since pH is a scalar quantity, the result may be displayed as monochromatic images, or they can be color enhanced to facilitate recognition.

For comparison with the microelectrode method, the result of this method is provided in FIGS. 15a and 15b, which show changes in pH along an 8 mm line with respect to a reference condition measured using 3 different methods, as a thin line 228 with small rectangular box data points (SPD PP). The pH change values obtained with the two different spectral methods are in substantial agreement. While there is more noise in the values obtained with the spectral method, in some instances this will be an acceptable sacrifice, considering that the spectral method allows measurements to be made about seven orders of magnitude faster.

A second comparison is made using a tungsten microelectrode to perform subsequent scans along a line, and calculating the change in pH using the difference in the microelectrode measurements, as indicated by the dashed lines 230 in FIGS. 15a and 15b. This is a slow process, in this case requiring about 10 minutes per scan, and thus the results of this method are not expected to precisely match the results of the spectral method. However, the values in the 8-10 mm range agree more than the values in the 2-4 mm range since their acquisition times are more similar.

Therefore, the method and apparatus formed in accordance with the present invention enable measurement of changes in pH from spectral information in digitized images. The general method may be applied to any system where a set of calibration values can be established that correlate an electrochemically significant quantity with spectral measurements made by means of an imaging detector. The general method is to transform the spectral measurements into a single variable x that can be mapped as a function f(x) to determine the electrochemically significant quantity. Electrochemically significant quantities measured in this way can be used to determine rates and/or amounts of electrochemical process.

In some situations, it may be preferable to estimate changes in the electrochemically significant quantity from a difference image with respect to a reference image. In this case, the change in the electrochemically significant quantity is estimated as Δf(x)=f(x_{ref})Δx. The benefit of using this approach is that, in some cases, the calculation of Δx from the difference of the present image with respect to the reference image shown in FIGS. 14a-c is faster than the calculation of the value of f(x) from the present image.

Therefore, the method and apparatus formed in accordance with the present invention are able to detect, enhance, and quantify physical, chemical, and electrochemical changes manifested in a visual image, such as pH, lead content, zinc content, potential difference, pitting, and corrosion, that occur over a period of time so that a human observer can readily discern these changes. In addition, the method and apparatus provide an efficient computer-based technique for detecting and monitoring changes in a visual image in real time using robust spectral information.

Although illustrative embodiments of the present invention have been described herein with reference to the accompanying drawing, it is to be understood that the invention is not limited to those precise embodiments, and that various other changes and modifications may be effected therein by one skilled in the art without departing from the scope or spirit of the invention.

1. A method of quantifying measurements associated with a subject using a visual image of the subject, the method comprising the steps of:
acquiring a digital representation of a first image of the subject, the first image being acquired at a first time, the digital representation of the first image including visual information associated with the first image;
acquiring a digital representation of a second image of the subject, the second image being acquired at a second time, the digital representation of the second image including visual information associated with the second image;
determining difference information, the difference information representing a change in at least one visual parameter between the digital representation of the first image and the digital representation of the second image; and
converting the difference information into subject information, the subject information representing at least one of a physical change, chemical change, electrical change, and electrochemical change associated with the subject.

2. A method of quantifying measurements associated with a subject using a visual image of the subject, as defined by claim 1, further comprising the step of adding a visual indicator to the subject, the visual indicator changing at least one visual parameter in response to the at least one of the physical change, chemical change, electrical change, and electrochemical change associated with the subject.

3. A method of quantifying measurements associated with a subject using a visual image of the subject, as defined by claim 1, wherein the subject information includes at least one of pH, lead content, zinc content, potential difference, pitting, and corrosion.

4. A method of quantifying measurements associated with a subject using a visual image of the subject, as defined by claim 1, wherein the at least one visual parameter includes at least one of color, tint, hue, brightness, shade, and tone.

5. A method of quantifying measurements associated with a subject using a visual image of the subject, as defined by claim 1, further comprising the step of adding an offset to at least a portion of the difference information.

6. A method of quantifying measurements associated with a subject using a visual image of the subject, as defined by claim 1, further comprising the step of multiplying at least a portion of the difference information by a gain.

7. A method of quantifying measurements associated with a subject using a visual image of the subject, as defined by claim 1, further comprising the step of acquiring analog information associated with the subject.

8. A method of quantifying measurements associated with a subject using a visual image of the subject, as defined by claim 7, wherein the step of acquiring analog information further comprises the step of acquiring at least one of voltage information and current information using a potentiostat.

9. A method of quantifying measurements associated with a subject using a visual image of the subject, as defined by claim 1, further comprising the steps of:
comparing at least a portion of the difference information to a threshold value; and
associating that portion of the difference information that is one of less than and greater than the threshold value with a region of interest, the region of interest being associated with the subject.

10. A method of quantifying measurements associated with a subject using a visual image of the subject, as defined by claim 9, further comprising the step of substituting a predetermined value for that portion of the difference information that is not within the region of interest.

11. A method of quantifying measurements associated with a subject using a visual image of the subject, as defined by claim 1, further comprising the step of generating a histogram, the histogram being representative of an intensity as a function of a quantity of pixels having the intensity, the histogram being representative of at least a portion of at least one of the first image and the second image.

12. A method of quantifying measurements associated with a subject using a visual image of the subject, as defined by claim 11, further comprising the step of determining a peak value of the histogram as a function of time.

13. A method of quantifying measurements associated with a subject using a visual image of the subject, as defined by claim 1, further comprising the step of overlaying at least a portion of the difference information on at least one of the first image and the second image to yield a processed image.

14. A method of quantifying measurements associated with a subject using a visual image of the subject, as defined by claim 1, further comprising the step of illuminating the subject with at least one of a monochromatic light and a polychromatic light.

15. A method of quantifying measurements associated with a subject using a visual image of the subject, as defined by claim 1, further comprising the step of acquiring the first image and the second image using at least one of a black and white camera and a color camera.

16. A method of quantifying measurements associated with a subject using a visual image of the subject, as defined by claim 1, wherein each of the first image and the second image includes at least one pixel, the at least one pixel associated with the first image including a first RGB value, the at least one pixel associated with the second image including a second RGB value, wherein the step of converting difference information further comprises the steps of:
converting the first RGB value into a first rgb tristimulus value and converting the second RGB value into a second rgb tristimulus value in accordance with the equations
r=R/(R+G+B) (49)
g=G/(R+G+B) (50)
b=B/(R+G+B) (51)
R representing an intensity of red associated with the at least one pixel, G representing an intensity of green associated with the at least one pixel, B representing an intensity of blue associated with the at least one pixel, r representing a red tristimulus value, g representing a green tristimulus value, b representing a blue tristimulus value;
converting the first rgb tristimulus value into a first spectral power distribution and converting the second rgb tristimulus value into a second spectral power distribution in accordance with the equation
spectral power distribution=r r+g g+b b (52)
r representing a red color matching function, g representing a green color matching function, b representing a blue color matching function, the first spectral power distribution including at least one first spectral power element, the second spectral power distribution including at least one second spectral power element;
obtaining an equation representing the subject information as a function of at least one spectral power distribution peak, the at least one spectral power distribution peak being associated with the first spectral power distribution;
subtracting the at least one first spectral power element and the at least one second spectral power element to yield a difference spectral power element; and
multiplying the difference spectral power element by a derivative of the equation representing the subject information as a function of the at least one spectral power distribution peak to represent the at least one of the physical change, chemical change, electrical change, and electrochemical change associated with the subject.

17. A method of quantifying measurements associated with a subject using a visual image of the subject, as defined by claim 1, wherein each of the first image and the second image includes a plurality of pixels, each of the plurality of pixels associated with the first image including a first RGB value, each of the plurality of pixels associated with the second image including a second RGB value, wherein the step of converting the difference information further comprises the steps of:
converting the first RGB values into first rgb tristimulus values and converting the second RGB values into second rgb tristimulus values in accordance with the equations
r=R/(R+G+B) (49)
g=G/(R+G+B) (50)
b=B/(R+G+B) (51)
R representing an intensity of red associated with the at least one pixel, G representing an intensity of green associated with the at least one pixel, B representing an intensity of blue associated with the at least one pixel, r representing a red tristimulus value, g representing a green tristimulus value, b representing a blue tristimulus value;
converting the first rgb tristimulus values into first spectral power distributions and converting the second rgb tristimulus values into second spectral power distributions in accordance with the equation
spectral power distribution=r r+g g+b b (52)
r representing a red color matching function, g representing a green color matching function, b representing a blue color matching function;
multiplying first spectral power distribution peaks associated with the first spectral power distribution to yield a first spectral power distribution peak product;
multiplying second spectral power distribution peaks associated with the second spectral power distribution to yield a second spectral power distribution peak product;
subtracting the first spectral power distribution peak product and the second spectral power distribution peak product to yield a difference spectral power distribution peak product;
obtaining an equation representing the subject information as a function of the first spectral power distribution peak product; and
multiplying the difference spectral power distribution peak product by a derivative of the equation representing the subject information as a function of the first spectral power distribution peak product to represent the at least one of the physical change, chemical change, electrical change, and electrochemical change associated with the subject.

18. An apparatus for quantifying measurements associated with a subject using a visual image of the subject, the apparatus comprising:
a digital camera, the digital camera acquiring a digital representation of a first image of a subject, the first image being acquired at a first time, the digital representation of the first image including visual information associated with the first image, the digital camera acquiring a digital representation of a second image of the subject, the second image being acquired at a second time, the digital representation of the second image including visual information associated with the second image; and
a computer, the computer being responsive to the digital representations of the first image and the second image, the computer determining difference information representing a change in the at least one visual parameter between the digital representation of the first image and the digital representation of the second image, the computer converting the difference information into subject information representing at least one of a physical change, chemical change, electrical change, and electrochemical change associated with the subject.

19. An apparatus for quantifying measurements associated with a subject using a visual image of the subject, as defined by claim 18, wherein a visual indicator is added to the subject, the visual indicator changing at least one visual parameter in response to the at least one of the physical change, chemical change, electrical change, and electrochemical change associated with the subject.

20. An apparatus for quantifying measurements associated with a subject using a visual image of the subject, as defined by claim 18, wherein the subject information includes at least one of pH, lead content, zinc content, potential difference, pitting, and corrosion.

21. An apparatus for quantifying measurements associated with a subject using a visual image of the subject, as defined by claim 18, wherein the at least one visual parameter includes at least one of color, tint, hue, brightness, shade, and tone.

22. An apparatus for quantifying measurements associated with a subject using a visual image of the subject, as defined by claim 18, wherein the visual information is associated with at least two of a red color plane, green color plane, and blue color plane for each pixel of at least one of the first image and the second image.

23. An apparatus for quantifying measurements associated with a subject using a visual image of the subject, as defined by claim 18, wherein the computer adds an offset to at least a portion of the difference information.

24. An apparatus for quantifying measurements associated with a subject using a visual image of the subject, as defined by claim 18 wherein the computer multiplies at least a portion of the difference information by a gain.

25. An apparatus for quantifying measurements associated with a subject using a visual image of the subject, as defined by claim 18, further comprising a potentiostat, the computer being responsive to the potentiostat, the potentiostat acquiring analog information associated with the subject.

26. An apparatus for quantifying measurements associated with a subject using a visual image of the subject, as defined by claim 25, wherein the potentiostat acquires at least one of voltage information and current information.

27. An apparatus for quantifying measurements associated with a subject using a visual image of the subject, as defined by claim 18, wherein the computer compares at least a portion of the difference information to a threshold value, the computer associating that portion of the difference spectral information that is one of less than and greater than the threshold value with a region of interest, the region of interest being associated with the subject.

28. An apparatus for quantifying measurements associated with a subject using a visual image of the subject, as defined by claim 27, wherein the computer substitutes a predetermined value for that portion of the difference spectral information that is not within the region of interest.

29. An apparatus for quantifying measurements associated with a subject using a visual image of the subject, as defined by claim 18, wherein the computer generates a histogram, the histogram being representative of intensity as a function of a quantity of pixels having the intensity, the intensity being associated with at least one of the at least two colors, the histogram being associated with at least a portion of at least one of the first image and the second image.

30. An apparatus for quantifying measurements associated with a subject using a visual image of the subject, as defined by claim 29, wherein the computer determines a peak value of the histogram as a function of time, the peak value being associated with at least one of the at least two colors.

31. An apparatus for quantifying measurements associated with a subject using a visual image of the subject, as defined by claim 18, wherein the computer superimposes at least a portion of the difference information on at least one of the first image and the second image to yield a processed image.

32. An apparatus for quantifying measurements associated with a subject using a visual image of the subject, as defined by claim 18, further comprising a camera positioning bracket, the camera positioning bracket being mechanically coupled to the digital camera, the camera positioning bracket selectively positioning the digital camera in at least one of an x, y, and z direction.

33. An apparatus for quantifying measurements associated with a subject using a visual image of the subject, as defined by claim 18, further comprising a subject positioning bracket, the subject positioning bracket being mechanically coupled to the subject, the subject positioning bracket selectively positioning the subject in at least one of an x, y, and z direction.

34. An apparatus for quantifying measurements associated with a subject using a visual image of the subject, as defined by claim 18, further comprising an illumination source including at least one of a monochromatic light and a polychromatic light.

35. An apparatus for quantifying measurements associated with a subject using a visual image of the subject, as defined by claim 18, further comprising at least one of a black and white camera and a color camera used to acquire the first image and the second image.

36. A method of quantifying measurements associated with a subject using a visual image of the subject, the method comprising the steps of:
adding a visual indicator to a subject, the indicator changing at least one visual parameter in response to at least one of a physical change, chemical change, electrical change, and electrochemical change associated with the subject;
acquiring a digital representation of a first image of the subject, the first image being acquired at a first time, the digital representation of the first image including visual information associated with the first image;
acquiring a digital representation of a second image of the subject, the second image being acquired at a second time, the digital representation of the second image including visual information associated with the second image;
determining difference information, the difference information representing a change in the at least one visual parameter between the digital representation of the first image and the digital representation of and the second image;
converting the difference information into physical information, the subject information representing the at least one of the physical change, chemical change, electrical change, and electrochemical change associated with the subject;
adding an offset selectively to at least a portion of the difference information;
multiplying at least a portion of the difference information selectively by a gain; and
displaying a processed image, the processed image including at least a portion of the difference information.

37. An apparatus for quantifying measurements associated with a subject using a visual image of the subject, the apparatus comprising:
a digital camera, the digital camera acquiring a digital representation of a first image of a subject, the first image being acquired at a first time, the digital representation of the first image including visual information associated with the first image, the digital camera acquiring a digital representation of a second image of the subject, the second image being acquired at a second time, the digital representation of the second image including visual information associated with the second image; and
a computer, the computer being responsive to the digital representation of the first image and the second image, the computer determining difference information representing a change in the at least one visual parameter between the digital representation of the first image and the digital representation of the second image, the computer selectively adding an offset to at least a portion of the difference information, the computer selectively multiplying at least a portion of the difference information by a gain, the computer converting the difference information into subject information representing at least one of a physical change, chemical change, electrical change, and electrochemical change associated with the subject.
